(19) United States
(12) Patent Application Publication
(10) Pub. No.: US 2015/0229620 A1
(43) Pub. Date: Aug. 13, 2015

(54) KEY MANAGEMENT IN MACHINE TYPE COMMUNICATION SYSTEM

(71) Applicant: NEC CORPORATION, Minato-ku, Tokyo, (JP)

(72) Inventors: Xiaowei Zhang, Tokyo (JP); Anand Raghawa Prasad, Tokyo (JP)

(73) Assignee: NEC Corporation, Tokyo (JP)

(21) Appl. No.: 14/426,942

(22) PCT Filed: Sep. 12, 2013
(86) PCT No.: PCT/JP2013/005398

§ 371 Date: Mar. 9, 2015

(30) Foreign Application Priority Data
Sep. 13, 2012 (JP) 2012-201693

(51) Int. Cl. H04L 29/06

(52) U.S. Cl. CPC H04L 63/062; H04L 63/10

(57) ABSTRACT

A MTC device (10) and a MTC interworking function, MTC-IWF, (20) form a communication system and conduct communication with each other. In this communication system, a root key (K_iwf) is securely shared between the MTC device (10) and the MTC-IWF (20). The MTC device (10) and the MTC-IWF (20) use the root key (K_iwf) to respectively derive temporary keys (K_di (K_di_conf, K_di_int)) for protecting the communication. The temporary keys provide integrity protection and confidentiality. The root key can be derived by the HSS or MME/SGSN/MSC and provided to the MTC-IWF. The root key can also be derived by the MTC-IWF based on received key derivation material. The described system is useful for the security of small data transmission in MTC system.

### TECHNICAL FIELD

The present invention relates to key management in MTC (Machine-Type Communication) system.

### BACKGROUND ART

As described in NPL 1, the security over the interface between MTC device and MTC-IWF (MTC Inter-Working Function) should be studied. However, the study has not been fulfilled. Currently, there is no security solution over the interface between MTC device and MTC-IWF in 3GPP (3rd Generation Partnership Project) SA3.

### CITATION LIST

### Non Patent Literature

NPL 1: 3GPP TR 33.868, “Security aspects of Machine-Type Communications; (Release 11)”, v0.9.0, 2012-07, Clause 4

### SUMMARY OF INVENTION

### Technical Problem

As discussed above, secure communication is required between MTC device and MTC-IWF.

MTC-IWF supports to authorize SCS (Service Capability Server) and to authorize control plane requests from SCS including trigger. MTC-IWF also delivers the messages (e.g. trigger message) from SCS to MTC devices. Man-in-the-middle and replay attack may happen on the interface between MTC device and MTC-IWF. Also, MME (Mobility Management Entity) does not need to have knowledge about SCS and the message content that it forwards. Therefore it is reasonable to have end-to-end security between MTC device and MTC-IWF.

### Solution to Problem

In order to solve the above-mentioned problems, a communication system according to first exemplary aspect of the present invention includes a MTC device; and a MTC-IWF that conducts communication with the MTC device. In this system, a root key is securely shared between the MTC device and the MTC-IWF. The MTC device and the MTC-IWF use the root key to respectively derive temporary keys for protecting the communication.

Further, a MTC-IWF according to second exemplary aspect of the present invention includes a communication means for conducting communication with a MTC device; a sharing means for securely sharing a root key with the MTC device; and a derivation means for deriving temporary keys by use of the root key for protecting the communication.

Further, a MTC device according to third exemplary aspect of the present invention includes a communication means for conducting communication with a MTC-IWF; a sharing means for securely sharing a root key with the MTC-IWF; and a derivation means for deriving temporary keys by use of the root key for protecting the communication.

Further, a network entity according to fourth exemplary aspect of the present invention is placed within a core network to which a MTC device attached. This network entity includes a derivation means for deriving a root key; and a send means for sending the root key to a MTC-IWF that conducts communication with the MTC device.

Further, a network entity according to fifth exemplary aspect of the present invention is placed within a core network to which a MTC device attached. This network entity includes a send means for sending, to a MTC-IWF that conducts communication with the MTC device, materials for the MTC-IWF to derive a root key.

Further, a method according to sixth exemplary aspect of the present invention provides a method of controlling operations in a MTC-IWF. This method includes conducting communication with a MTC device; securely sharing a root key with the MTC device; and deriving temporary keys by use of the root key for protecting the communication.

Further, a method according to seventh exemplary aspect of the present invention provides a method of controlling operations in a MTC device. This method includes conducting communication with a MTC-IWF; securely sharing a root key with the MTC-IWF; and deriving temporary keys by use of the root key for protecting the communication.

Further, a method according to eighth exemplary aspect of the present invention provides a method of controlling operations in a network entity placed within a core network to which a MTC device attached. This method includes deriving a root key; and sending the root key to a MTC-IWF that conducts communication with the MTC device.

Furthermore, a method according to ninth exemplary aspect of the present invention provides a method of controlling operations in a network entity placed within a core network to which a MTC device attached. This method includes sending, to a MTC-IWF that conducts communication with the MTC device, materials for the MTC-IWF to derive a root key.

### Advantageous Effects of Invention

According to the present invention, it is possible to solve the above-mentioned problems, so that for example, the following effects (1) to (3) can be achieved.

(1) End-to-end security can be provided by protecting the messages between MTC-IWF and UE (User Equipment) with the proposed keys.

(2) UE can perform MTC-IWF authorization by integrity check of the messages sent from MTC-IWF, with using the proposed keys.

(3) The message can be serving node (MME/SGSN/MSC) independent. Messages sent from MTC-IWF can be delivered to UE, even the serving node is changed due to UE mobility, or network failure. UE doesn't need to perform source authentication and authorization again.

### BRIEF DESCRIPTION OF DRAWINGS

FIG. 1 is a block diagram showing a configuration example of a communication system according to an exemplary embodiment of the present invention.

FIG. 2 is a block diagram showing a key hierarchy in the communication system according to the exemplary embodiment.

FIG. 3 is a sequence diagram showing a first operation example of the communication system according to the exemplary embodiment.

FIG. 4 is a sequence diagram showing a second operation example of the communication system according to the exemplary embodiment.

FIG. 5 is a sequence diagram showing a third operation example of the communication system according to the exemplary embodiment.

FIG. 6 is a block diagram showing a configuration example of a MTC-IWF according to the exemplary embodiment.

FIG. 7 is a block diagram showing a configuration example of a MTC device according to the exemplary embodiment.

FIG. 8 is a block diagram showing a configuration example of a network entity according to the exemplary embodiment.

### DESCRIPTION OF EMBODIMENTS

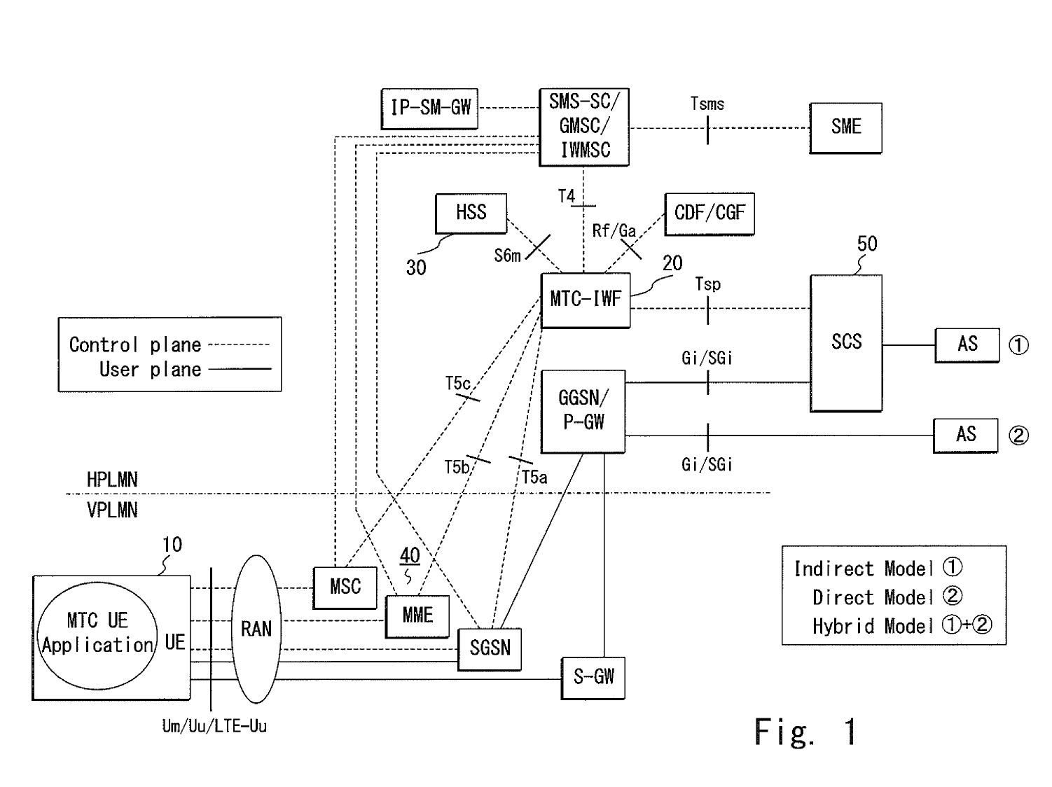

Hereinafter, an exemplary embodiment of the present invention will be described with reference to FIGS. 1 to 8.

As shown in FIG. 1, a communication system according to this exemplary embodiment includes a core network (3GPP network), and one or more MTC devices 10 which connect to the core network through a RAN (Radio Access Network). Note that, in this exemplary embodiment, the definition of MTC device follows that in NPL 1 that “A MTC Device is a UE equipped for Machine Type Communication”. While the illustration is omitted, the RAN is formed by a plurality of base stations (i.e., eNBs (evolved Node Bs)).

The MTC device 10 attaches to the core network. The MTC device 10 can host one or multiple MTC Applications. The corresponding MTC Applications in the external network are hosted on one or multiple as (Application Servers).

Further, the core network includes a MTC-IWF 20. The MTC-IWF 20 serves as a network entity relaying messages between the MTC device 10 and SCS 50 which connects to the core network to communicate with the MTC device 10. The core network includes, as other network entities, an HSS (Home Subscriber Server) 30, an MME, an SGSN (Serving GPRS (General Packet Radio Service) Support Node), an MSC (Mobile Switching Centre) and the like. In the following description, the MME, SGSN and MSC are sometimes referred to as “MME/SGSN/MSC” and collectively denoted by the symbol 40. Communication between the MTC device 10 and the MTC-IWF 20 is conducted through the MME/SGSN/MSC 40.

Furthermore, a few assumptions are made for this exemplary embodiment as follows:

The UE (MTC device 10) and core network (HSS 30, MME/SGSN/MSC 40) have mutual authenticated.

The security association is established between HSS 30, MME/SGSN/MSC 40 and MTC-IWF 20.

This exemplary embodiment proposes to derive and allocate keys that MTC-IWF 20 and UE (MTC device 10) share with each other. The keys are for confidentiality and integrity protection of the communication between MTC-IWF 20 and UE (MTC device 10).

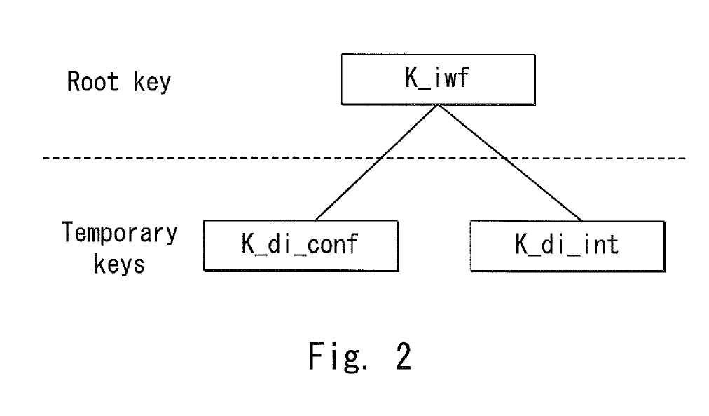

Specifically, as shown in FIG. 2, this exemplary embodiment proposes to have a key hierarchy with root key and temporary key. The root key K_iwf is used to derive a pair of temporary keys K_di (K_di_conf, K_di int). K_di_conf is a confidentiality key for encrypting and decrypting messages transferred between the MTC device 10 and the MTC-IWF 20. K_di_int is an integrity key for protecting and checking the integrity of messages transferred between the MTC device 10 and the MTC-IWF 20.

The use of temporary keys is because that any attack on temporary keys will not lead to compromise of root key which is at a higher level in the hierarchy, such that the root key can be used to re-derive new keys that in turn mitigates issues created by compromised lower layer keys.

Further, the MTC device 10 may authorize the MTC-IWF 20 in accordance with a result of the integrity check. Specifically, the MTC device 10 authorizes the MTC-IWF 20 as a true one when succeeding in the integrity check. In this case, it is possible to prevent the MTC device 10 from communicating with a MTC-IWF masquerading as the true one, even when the MTC device 10 connects to a false network. It is preferable that these integrity check and authorization are applied to a roaming UE/MTC device.

Next, operation examples of this exemplary embodiment will be described in detail.

[1]. Derivation and allocation of the root key K_iwf

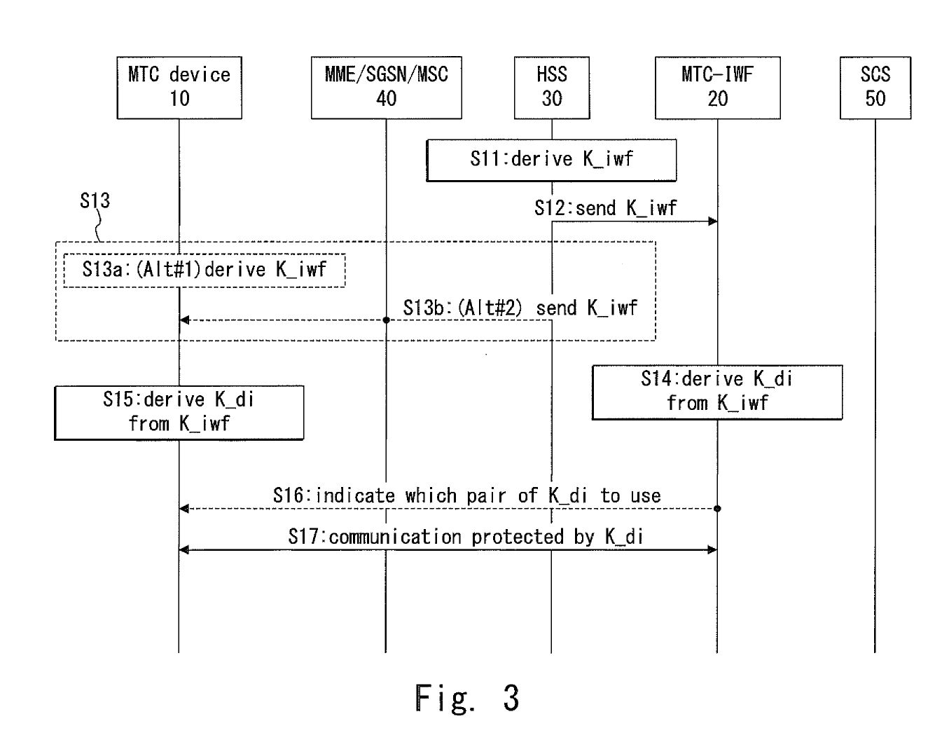

K_iwf can be derived by HSS 30, MME/SGSN/MSC 40 or MTC-IWF 20. The 3 scenarios are shown in FIGS. 3, 4 and 5.

Key distribution can be done in two ways as given below.

### (1) Distributed

(A) Given network entity (HSS 30 or MME/SGSN/MSC 40) sends the key to MTC-IWF, in case that the root key is not derived by MTC-IWF 20 itself, and

(B) UE.

Note that the key being sent to UE should be after the security is established between MTC device 10 and network (HSS 30 and MME/SGSN/MSC 40), and it should be protected with valid security context.

### (2) Synchronized

(A) Given network entity (HSS 30 or MME/SGSN/MSC 40) sends the key to MTC-IWF 20 or MTC-IWF 20 derives the root key by itself.

(B) UE derives the same key.

### [2]. Temporary Keys

After the root key is derived, UE (MTC device 10) and MTC-IWF 20 will derive the pair of temporary keys that are used to protect the communication between MTC-IWF 20 and UE (MTC device 10).

Temporary key derivation at network side is done by the serving MTC-IWF 20. When MTC-IWF 20 first time needs to communicate with a given UE, it derives a pair or a few pair of temporary keys from the root key. UE derives the same temporary keys in the same way that MTC-IWF 20 does. In the case where there is more than one pair of temporary keys, MTC-IWF 20 will indicate UE which one to use for the communication. And UE will choose the one that MTC-IWF 20 indicated.

### [3]. Input Parameters for Key Derivation

K_iwf can be derived as follows.

(1) K_iwf can be derived from CK (Cipher Key), IK (Integrity Key). In this case, it can re-use part of the existing key hierarchy.

(2) K_iwf can be derived from Kasme (Key Access Security Management Entity). It can re-use part of the existing key hierarchy.

(3) K_iwf can be derived separately from the 3GPP key hierarchy.

Other values will be also used as input parameters for K_iwf derivation.

K_di can be derived using K_iwf and other input parameters.

### [4]. Key Storage

Both root key (K_iwf) and temporary keys (K_di_conf, K_di_int) can be stored in USIM (Universal Subscriber Identity Module) or non-volatile memory of ME (Mobile Equipment).

The 3 scenarios of root key derivation are subsequently described with reference to FIGS. 3, 4 and 5.

FIG. 3 shows the key derivation and allocation, when HSS 30 derives the root key.

(S11) HSS 30 derives the root key K_iwf with CK, IK as the input keys.

(S12) HSS 30 sends the root key K_iwf to MTC-IWF 20. (S13) MTC device 10 derives the same root key K_iwf (S13a) or alternatively, HSS 30 sends the root key K_iwf to MTC device 10 (S13b), this should be after the NAS and/or AS security is established.

(S14) MTC-IWF 20 derives the temporary keys from K_iwf.

(S15) MTC device 10 derives the same temporary keys from the K_iwf it has, in the same way that MTC-IWF 20 does.

(S16) MTC-IWF 20 indicates MTC device 10 which pair of temporary keys it should use, if more than one pair of temporary keys are derived.

(S17) Messages transferred between MTC device and MTC-IWF are protected by the pair of temporary keys.

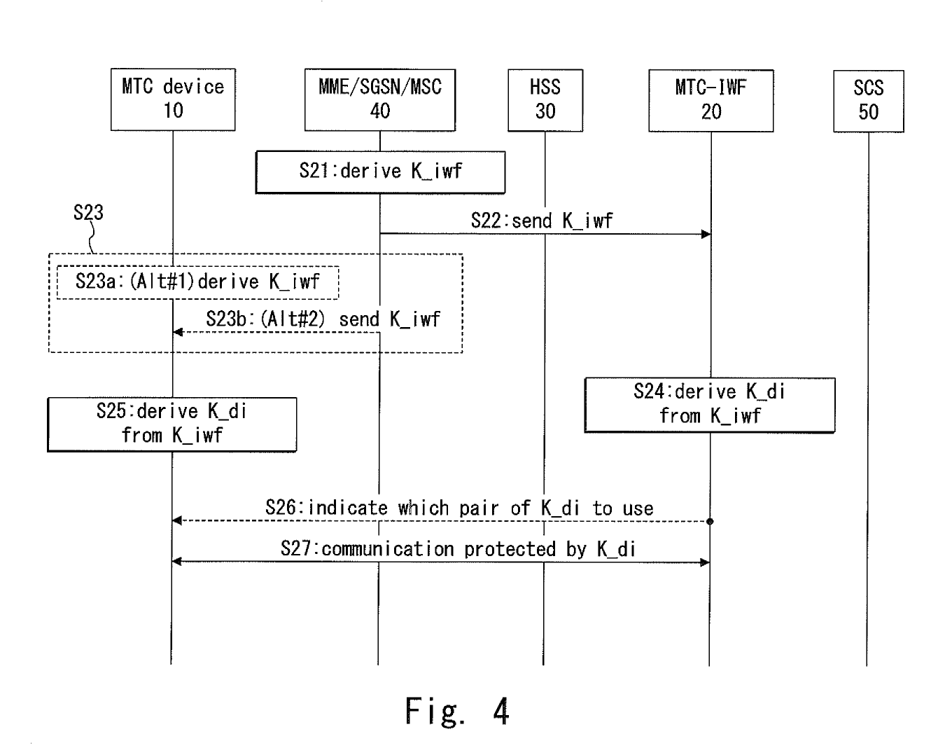

FIG. 4 shows the key derivation and allocation, when MME/SGSN/MSC 40 derives the root key.

(S21) MME/SGSN/MSC 40 derives the root key K_iwf with Kasme as the input key.

(S22) MME/SGSN/MSC 40 sends the root key K_iwf to MTC-IWF 20.

(S23) MTC device 10 derives the same root key K_iwf (S23a) or alternatively, MME/SGSN/MSC 40 sends the root key K_iwf to MTC device 10 (S23b), this should be after the NAS and/or AS security is established.

(S24) MTC-IWF 20 derives the temporary keys from K_iwf. (S25) MTC device 10 derives the same temporary keys from the K_iwf it has, in the same way that MTC-IWF 20 does.

(S26) MTC-IWF 20 indicates MTC device 10 which pair of temporary keys it should use, if more than one pair of temporary keys are derived.

(S27) Messages transferred between MTC device 10 and MTC-IWF 20 are protected by the pair of temporary keys.

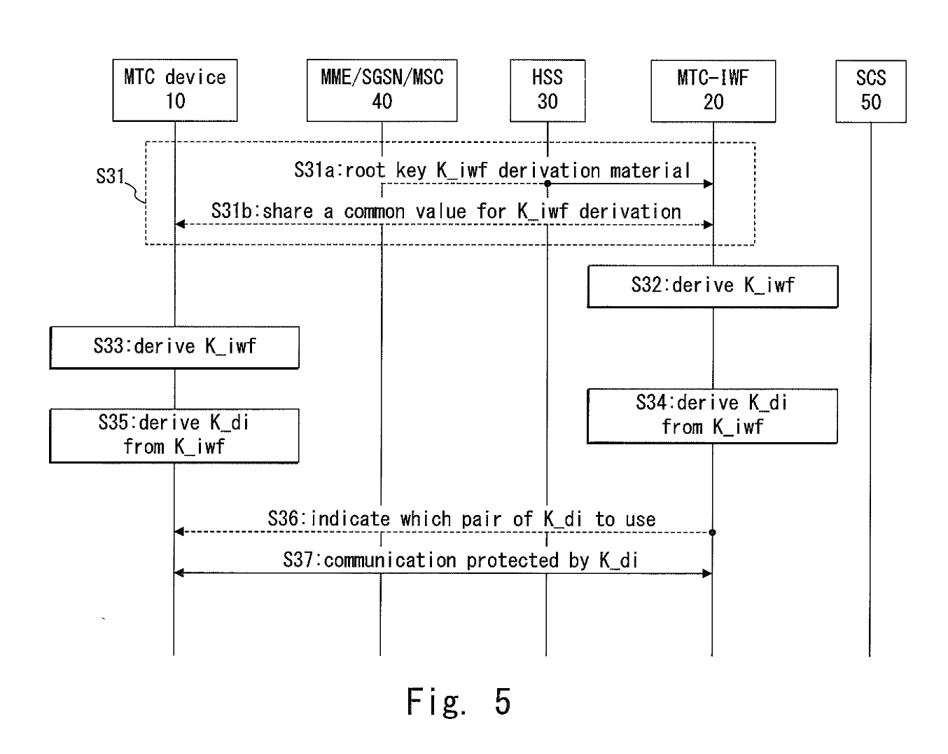

FIG. 5 shows the key derivation and allocation, when MTC-IWF 20 derives the root key.

(S31) MME/SGSN/MSC 40 or HSS 30 sends the material for root key K_iwf derivation to MTC-IWF 20 (S31a), or alternatively, MTC device 10 and MTC-IWF 20 have a common value for K iwf derivation (S31b).

(S32) MTC-IWF 20 derives the root key K_iwf.

(S33) MTC device 10 derives the same root key K_iwf.

(S34) MTC-IWF 20 derives the temporary keys from K_iwf.

(S35) MTC device 10 derives the same temporary keys from the K_iwf it has, in the same way that MTC-IWF 20 does.

(S36) MTC-IWF 20 indicates MTC device 10 which pair of temporary keys it should use, if more than one pair of temporary keys are derived.

(S37) Messages transferred between MTC device 10 and MTC-IWF 20 are protected by the pair of temporary keys.

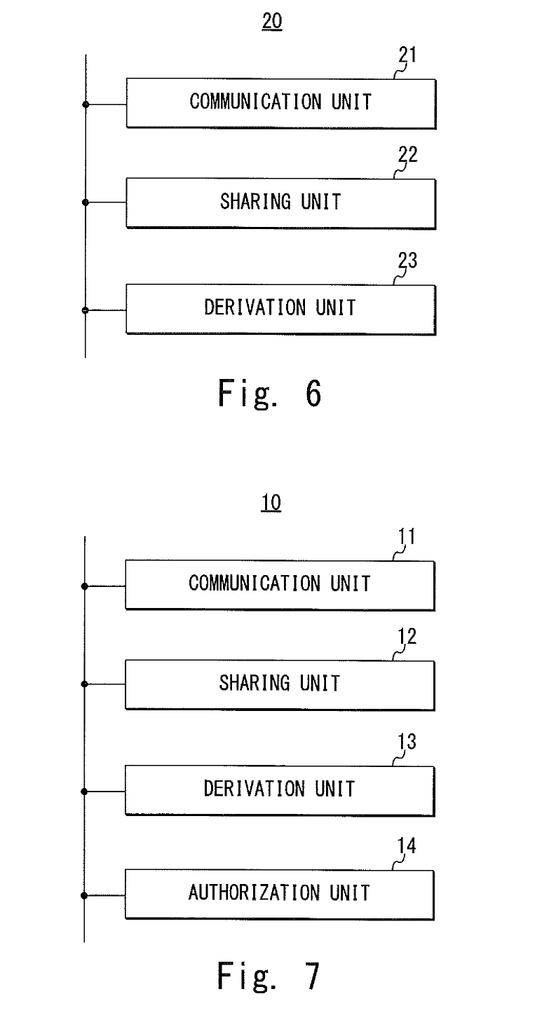

Next, configuration examples of the MTC-IWF 20, the MTC device 10 and the network entity (HSS 30 or MME/SGSN/MSC 40) according to this exemplary embodiment will be subsequently described with reference to FIGS. 6 to 8.

As shown in FIG. 6, the MTC-IWF 20 includes at least a communication unit 21, a sharing unit 22, and a derivation unit 23. The communication unit 21 conducts communication with the MTC device 10. The sharing unit 22 securely shares the root key K_iwf with the MTC device 10 in a manner shown any one of FIGS. 3 to 5. The derivation unit 23 derives the temporary keys K_di by use of the root key K_iwf for protecting the communication. As a result, the temporary keys K_di can be also shared between the MTC-IWF 20 and the MTC device 10. Note that these units 21 to 23 are mutually connected with each other thorough a bus or the like. These units 21 to 23 can be configured by, for example, transceivers which respectively conduct communication with the HSS 30, the MME/SGSN/MSC 40 and the SCS 50, and a controller which controls these transceivers to execute the processes shown at Steps S12, S14, S16 and S17 to S10 in FIG. 3, the processes shown at Steps S22, S24, S26 and S27 in FIG. 4, the processes shown at Steps S31, S32, S34, S36 and S37 in FIG. 5, or processes equivalent thereto.

Further, as shown in FIG. 7, the MTC device 10 includes at least a communication unit 11, a sharing unit 12, and a derivation unit 13. It is preferable that The MTC 10 further includes an authorization unit 14. The communication unit 11 conducts communication with the MTC-IWF 20. The sharing unit 12 securely shares the root key K_iwf with the MTC device 10 in a manner shown any one of FIGS. 3 to 5. The derivation unit 13 derives the temporary keys K_di by use of the root key K_iwf for protecting the communication. As a result, the temporary keys K_di can be also shared between the MTC device 10 and the MTC-IWF 20. The authorization unit 14 performs the integrity check by use of the integrity key K di int, and authorizes the MTC-IWF 20 in accordance with a result of the integrity check. Note that these units 11 to 14 are mutually connected with each other thorough a bus or the like. These units 11 to 14 can be configured by, for example, a transceiver which wirelessly conducts communication with the core network through the RAN, and a controller which controls this transceiver to execute the processes shown at Steps S13 and S15 to 17 in FIG. 3, the processes shown at Steps S23 and S25 to S27 in FIG. 4, the processes shown at Steps S31, S33 and S35 to S37 in FIG. 5, or processes equivalent thereto.

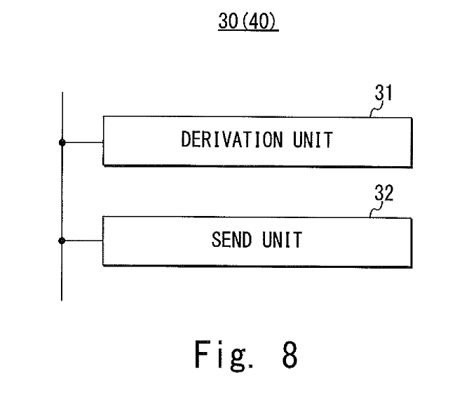

Furthermore, as shown in FIG. 8, each of the HSS 30 and the MME/SGSN/MSC 40 includes at least a derivation unit 31 and a send unit 32. The derivation unit 31 derives the root key K_iwf. The send unit 32 sends the root key K_iwf to the MTC-IWF 20. The send unit 32 may also send the root key K_iwf to the MTC device 10 after the NAS and/or AS security context is established between the MTC device 10 and each of the HSS 30 and the MME/SGSN/MSC 40. Alternatively, the send unit 32 sends materials for the root key K_iwf derivation to the MTC-IWF 20. Note that these units 31 and 32 are mutually connected with each other thorough a bus or the like. These units 31 and 32 can be configured by, for example, a transceiver which conducts communication with the MTC-IWF 20, a transceiver which conducts communication with the RAN in the case of the MME/SGSN/MSC 40, and a controller which controls these transceivers to execute the processes shown at Steps S11 to S13 in FIG. 3, the processes shown at Steps S21 to S23 in FIG. 4, the processes shown at Step S31 in FIG. 5, or processes equivalent thereto.

Note that the present invention is not limited to the above-mentioned exemplary embodiment, and it is obvious that various modifications can be made by those of ordinary skill in the art based on the recitation of the claims.

The whole or part of the exemplary embodiment disclosed above can be described as, but not limited to, the following supplementary notes.

### (Supplementary Note 1)

New key hierarchy is proposed for secure communication between MTC-IWF and UE/MTC device. It includes the following.

(A) A root key which is used to derive a pair of temporary keys.

(B) A pair of temporary keys including confidentiality and integrity keys for protecting the communication between MTC-IWF and UE/MTC device.

### (Supplementary Note 2)

New messages or new parameters in existing message for key management in 3GPP MTC architecture.

### (Supplementary Note 3)

Secure communication between MTC-IWF and UE/MTC device is provided, on top of the established NAS and/or AS security context.

### (Supplementary Note 4)

MTC-IWF authorization can be realized by UE/MTC device performing integrity check of the message received from MTC-IWF. This also applies to a roaming UE/MTC device.

This application is based upon and claims the benefit of priority from Japanese patent application No. 2012-201693, filed on Sep. 13, 2012, the disclosures of which are incorporated herein in their entirety by reference.

### REFERENCE SIGNS LIST

10 MTC DEVICE
11, 21 COMMUNICATION UNIT
12, 22 SHARING UNIT
13, 23, 31 DERIVATION UNIT
14 AUTHORIZATION UNIT
20 MTC-IWF
30 HSS
32 SEND UNIT
40 MME/SGSN/MSC

1. A communication system comprising:
a UE (User Equipment); and
MTC-IWF Machine-Type-Communication Inter-Working Function) that conducts communication with the UE,
wherein a first key is securely shared between the UE and the MTC-IWF, and
wherein the UE and the MTC-IWF respectively derive second keys from the first key for protecting the communication between the UE and the MTC-IWF.

2. The communication system according to claim 1, wherein the second keys include an integrity key for at least one of integrity cheek of a message transferred between the UE and the MTC-IWF, and integrity protection of the communication between the UE and the MTC-IWF.

3. The communication system according to claim 2, wherein the UE performs at least one of integrity check of the message and integrity protection of the communication by use of the integrity key, and performs MTC-IWF authorization in accordance with a result of the integrity check.

4. The communication system according to claim 1, wherein the second keys include a confidentiality key for encrypting and decrypting a message transferred between the UE and the MTC-IWF.

5. The communication system according to claim 1, wherein the communication is conducted through a different network entity placed within a core network to which the UE attached.

6. The communication system according to claim 1,
wherein the sharing of first key is performed in such a manner that:
the MTC-IWF receives a first key derived by a different network entity placed within a core network to which the UE attached; and
the UE derives a first key by the UE itself, or receives the derived first key from the different network entity after NAS and/or AS security context is established between the UE and the different network entity.

7. The communication system according to claim 1,
wherein the sharing of first key is performed in such a manner that:
the MTC-IWF receives materials from a different network entity placed within a core network to which the UE attached, and derives a first key by use of the materials; and
the UE derives a first key by the UE itself.

8-9. (canceled)

10. The communication system according to claim 1, wherein the sharing of first key is performed in such a manner that the MTC-IWF and the UE share as common value, and derive a first key by use of the common value independently.

11. A MTC-IWF Machine-Type-Communication Inter-Working Function) comprising:
a communication unit that conducts communication with a UE (User Equipment);
a sharing unit that securely shares a first key with the UE; and
a derivation unit that derives second keys, from the first key, for protecting the communication between the UE and the MTC-IWF.

12. The MTC-IWF according to claim 11, wherein the derivation unit is configured to derive, as one of the second keys, an integrity key for at least one of integrity check of a message received from the UE, and integrity protection of the communication between the UE and the MTC-IWF.

13. The MTC-IWF according to claim 11, wherein the derivation unit is configured to derive, as one of the second keys, a confidentiality key for encrypting a message to be transmitted to the UE and for decrypting a message received from the UE.

14. (canceled)

15. The MTC-IWF according to claim 11, wherein the sharing unit is configured to receive a first key derived by a different network entity placed within a core network to which the UE attached.

16. The MTC-IWF according to claim 11, wherein the sharing unit is configured to: receive materials from a different network entity placed within a core network to which the UE attached; and
derive a first key by use of the materials.

17. (canceled)

18. A UE (User Equipment) comprising:
a communication unit that conducts communication with a MTC-IWF Machine-Type-Communication Inter-Working Function);
a sharing unit that securely shares a first key with the MTC-IWF; and
a derivation unit that derives second keys, from the first key, for protecting the communication between the UE and the MTC-IWF.

19. The UE according to claim 18, wherein the derivation unit is configured to derive, one of the second keys, an integrity key for at least one of and integrity check of a message received from the MTC-IWF, and integrity protection of the communication between the UE and the MTC-IWF.

20. The UE according to claim 19, further comprising:
an authorization unit of at least one of integrity check of the message and integrity protection of the communication by use of the integrity key, and that authorizes the MTC-IWF in accordance with as result of the check.

21. The UE according to claim 18, wherein the derivation unit is configured to derive, one of the second keys, a confidentiality key for encrypting a message to be transmitted to the MTC-IWF and for decrypting a message received from the MTC-IWF.

22. (canceled)

23. The UE according to claim 18, wherein the sharing unit is configured to receive a first key derived by a different network entity placed within a core network to which the UE attached, after NAS and/or AS security context is established between the UE and the different network entity.

24-31. (canceled)

32. A method of controlling operations in a network entity placed within a core network to which a UE (User Equipment) attached, the method comprising:
deriving a first key; and
sending the first key to a MTC-IWF (Machine-Type Communication Inter-Working Function) that conducts communication with the UE.

33. The method according to claim 32, further comprising:
sending the first key to the UE after NAS (Non-Access Stratum) and/or AS (Access Stratum) security context is established between the UE and the network entity.

34. (canceled)
